(19) United States
(12) Patent Application Publication
(10) Pub. No.: US 2025/0219192 A1
(43) Pub. Date: Jul. 3, 2025

(54) BATTERY PACK AND VEHICLE

(71) Applicant: EVE ENERGY CO., LTD., Huizhou (CN)

(72) Inventor: Peng YANG, Huizhou (CN)

(73) Assignee: EVE ENERGY CO., LTD., Huizhou (CN)

(21) Appl. No.: 19/026,425

(22) Filed: Jan. 17, 2025

Related U.S. Application Data
(63) Continuation of application No. PCT/CN2024/108961, filed on Jul. 31, 2024.

(30) Foreign Application Priority Data
Dec. 28, 2023 (CN) 202323617645.3
Jul. 31, 2024 (WO) PCT/CN2024/108961

(51) Int. Cl. H01M 10/6556; H01M 10/613; H01M 10/653; H01M 10/6567; H01M 10/658; H01M 50/213; H01M 50/367; H01M 50/507

(52) U.S. Cl. CPC H01M 10/6556; H01M 10/613; H01M 10/653; H01M 10/6567; H01M 10/658; H01M 50/213; H01M 50/367; H01M 50/507

(57) ABSTRACT

The present disclosure provides a battery pack and a vehicle. The battery pack includes at least one first battery module, at least one second battery module, and a liquid cooling system. The second battery module and the first battery module are stacked in a first direction. The liquid cooling system includes a first liquid cooling plate and a second liquid cooling plate. The first liquid cooling plate is located at an end of the first battery module and between the first battery module and the second battery module. The second liquid cooling plate is located at an end of the second battery module away from the first battery module.

### CROSS-REFERENCE TO RELATED APPLICATION

This application is a continuation of an International Application No. PCT/CN2024/108961, filed on Jul. 31, 2024, which claims priority to Chinese Patent Application No. 202323617645.3 filed on Dec. 28, 2023, the disclosures of which are incorporated herein by reference in their entireties.

### TECHNICAL FIELD

The present disclosure relates to the field of battery technologies, and more particular to a battery pack and a vehicle.

### BACKGROUND

The 46-type large cylindrical battery cells having a larger volume can hold more charge, and have higher capacity and energy density. With the serialized production of the 46-type large cylindrical battery cells at home and abroad, a battery system design based on 46-type large cylindrical battery cells has become an important research and development direction for new energy vehicle battery systems.

### SUMMARY

The present disclosure provides a battery pack. The battery pack includes at least one first battery module, at least one second battery module, and a liquid cooling system. The second battery module and the first battery module are stacked in a first direction to form a double-layer battery module. The liquid cooling system includes a first liquid cooling plate and a second liquid cooling plate. The first liquid cooling plate is located at an end of the first battery module and between the first battery module and the second battery module. The second liquid cooling plate is located at an end of the second battery module away from the first battery module.

The present disclosure further provides a vehicle. The vehicle includes the battery pack as described above.

### DESCRIPTION OF THE DRAWINGS

FIG. 1 is an exploded view of a battery pack provided in some embodiments of the present disclosure.

FIG. 2 is a perspective view of a battery pack provided in some embodiments of the present disclosure.

FIG. 3 is a cross-sectional view taken along line B-B in FIG. 2. FIG. 4 is a cross-sectional view taken along line A-A in FIG. 2.

FIG. 5 is a schematic diagram of a thermal runaway pressure relief process of a second battery module provided in some embodiments of the present disclosure.

FIG. 6 is a perspective view of a box provided in some embodiments of the present disclosure.

FIG. 7 is a schematic structural diagram of a first liquid cooling plate provided in some embodiments of the present disclosure.

FIG. 8 is a schematic structural diagram of a vehicle provided in some embodiments of the present disclosure.

### REFERENCE NUMERALS OF THE ACCOMPANYING DRAWING

100. Battery pack; 1. First battery module; 10. First pressure relief cavity; 11. First cell tray; 12. First cell; 13. First integrated busbar; 2. Second battery module; 20. Second pressure relief cavity; 21. Second cell tray; 22. Second cell; 23. Second integrated busbar; 3. Liquid cooling system; 31. First liquid cooling plate; 311. Liquid cooling portion; 312. Connection portion; 313. Avoidance portion; 32. Second liquid cooling plate; 4. Box body; 41. Pressure relief channel; 42. Connection column; 43. Cross beam; 5. Box cover; 51. Connection hole; 6. Module frame; 7. Support assembly; 71. Support beam; 711. Through hole; 8. Thermal insulation assembly;

200. Vehicle.

### DETAILED DESCRIPTION

In description of the present application, it should be noted that the terms “interconnection”, “connection” and “fixing” should be understood in a broad sense, unless otherwise clearly specified and defined. For example, “fixing” can be a fixed connection, a detachable connection, or integrated connection. It can be a mechanical connection or an electrical connection. It can be directly connected or indirectly connected through an intermediary. It can also be the connection between two elements or the interaction between two elements. Those ordinary skilled in the art can understand the specific meanings of the above terms in the present application according to specific situations.

In the present disclosure, it should he noted that unless otherwise clearly defined and limited, a first feature “on” or “under” a second feature may mean that the first feature directly contacts the second feature, or that the first feature contacts the second feature via an additional feature there between instead of directly contacting the second feature. Moreover, the first feature “on”, “above”, and “over” the second feature may mean that the first feature is right over or obliquely upward over the second feature or mean that the first feature has a horizontal height higher than that of the second feature. The first feature “under”, “below”, and “beneath” the second feature may mean that the first feature is right beneath or obliquely downward beneath the second feature or mean that horizontal height of the first feature is lower than that of the second feature.

In the description of the present embodiments, orientations or position relationships indicated by the terms “upper”, “lower”, “left”, “right”, “front”, and “back” are based on orientations or position relationships illustrated in the drawings. The terms are used to facilitate and simplify the description and operations of the present application, rather than indicate or imply that the devices or elements referred to herein are required to have specific orientations or be constructed or operate in the specific orientations. Accordingly, the terms should not be construed as limiting the present application. In addition, the terms “first” and “second” are used for the purpose of distinguishing elements in terms of description of the elements and not in a particular sense.

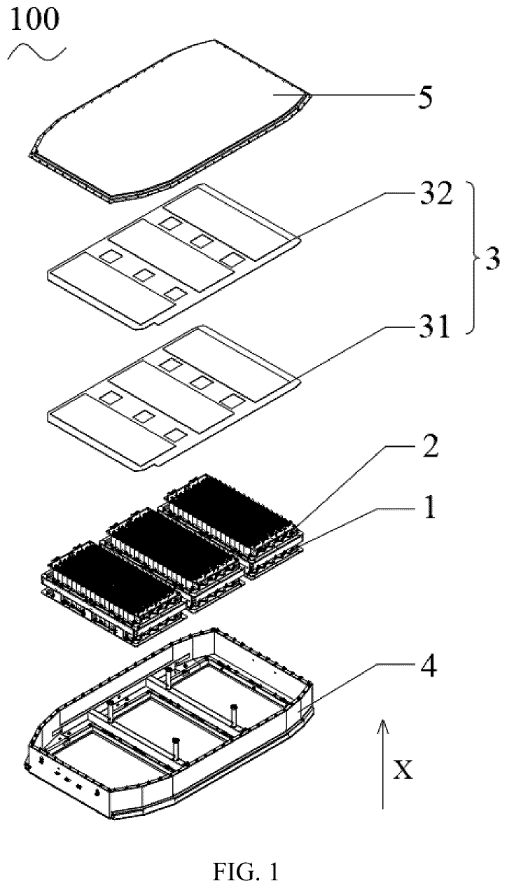

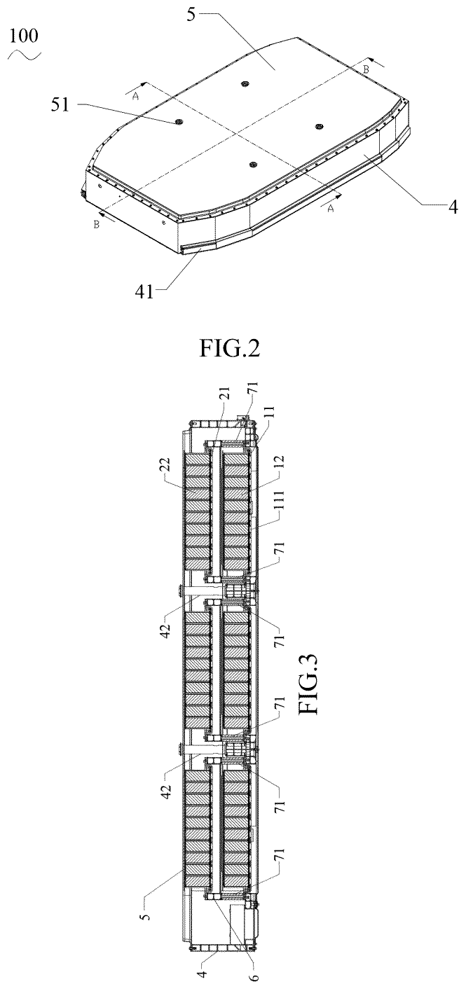

As shown in FIGS. 1, 3, and 5, some embodiments of the present disclosure provide a battery pack, including at least one first battery module 1, at least one second battery module 2, and a liquid cooling system 3. The second battery module 2 and the first battery module 1 are stacked in a first direction X to form a double-layer battery module.

By stacking the first battery module 1 and the second battery module 2 in the first direction X to form the double-layer battery module, the battery pack 100 including the double-layer battery module can be formed. When the battery pack 100 is installed in a vehicle, a vertical space of the entire vehicle can be fully utilized to meet the requirements of high energy and long endurance of the vehicle.

It should be noted that the battery pack 100 provided in the embodiments of the present disclosure may include only one double-layer battery module or multiple double-layer battery modules. For example, as shown in FIG. 1, the battery pack includes three double-layer battery modules at the same time. That is, three second battery modules 2 are stacked on top of three first battery modules 1, respectively. By including the plurality of double-layer battery modules in the same battery pack 100, the integration of the battery pack 100 can be improved, further meeting the requirements of long endurance of the vehicle.

As shown in FIGS. 1 and 5, the liquid cooling system 3 includes a first liquid cooling plate 31 and a second liquid cooling plate 32. The first liquid cooling plate 31 is located at an end of the first battery module 1 and between the first battery module 1 and the second battery module 2. The second liquid cooling plate 32 is located at an end of the second battery module 2 away from the first battery module 1.

That is, the first liquid cooling plate 31 and the second liquid cooling plate 32 are attached to a top portion of the first battery module 1 and a top portion of the second battery module 2, respectively, so as to effectively liquid cool a position where the battery pack 100 generates a large amount of heat during operation of the battery pack 100, thereby improving the thermal safety and reliability of the battery pack 100. The top portion of each of the first battery module 1 and the second battery module 2 may refer to an end of a cell of the each of the first battery module 1 and the second battery module 2 having a tab.

It should be understood that the exploded view shown in FIG. 1 is only used to illustrate components included in the battery pack 100 provided in the embodiments of the present disclosure, and is not used to limit the positional relationship between the various components.

In some embodiments of the present disclosure, the battery pack 100 further includes a box body 4 and a box cover 5. The box body 4 has an accommodating cavity, the first battery module 1, the second battery module 2 and the liquid cooling system 3 are all disposed in the accommodating cavity, and the box cover 5 covers the box body 4.

The box body 4 and the box cover 5 are used to form a shell structure for accommodating the first battery module 1, the second battery module 2 and the liquid cooling system 3, which can provide effective protection for the first battery module 1, the second battery module 2 and the liquid cooling system 3 and improve the overall structural stability of the battery pack 100.

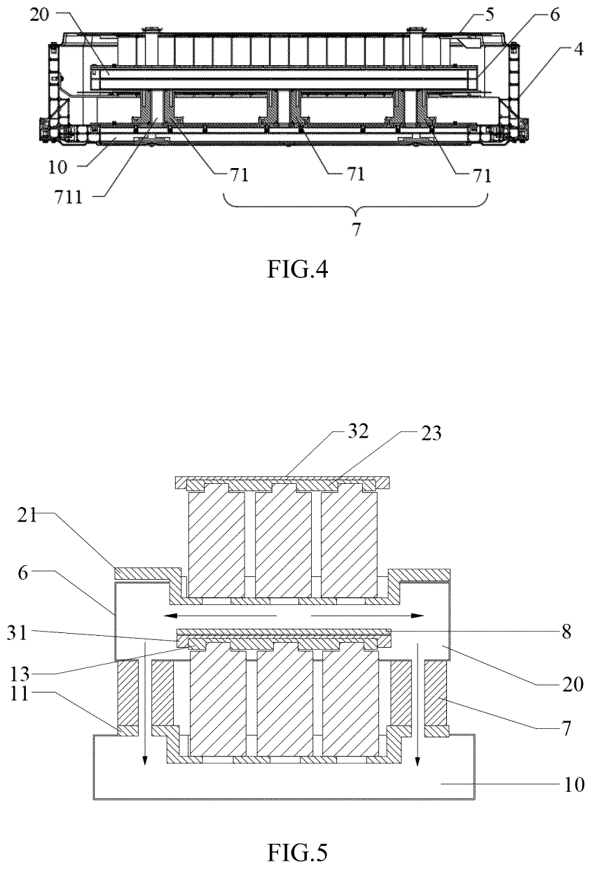

In some embodiments of the present disclosure, as shown in FIGS. 3-5, the first battery module 1 includes a first cell tray 11, a plurality of first cells 12, and a first integrated busbar 13. The first cell tray 11 is disposed at a bottom portion of the box body 4 and is used to form a first pressure relief cavity 10 together with the box body 4. The plurality of first cells 12 are installed on the first cell tray 11. The first integrated busbar 13 is disposed on a side of the first cells 12 away from the first cell tray 11 and is connected to the plurality of first cells 12. The box body 4 is provided with a pressure relief channel 41, and the first pressure relief cavity 10 is respectively connected with the pressure relief channel 41 and explosion-proof valves of the plurality of first cells 12.

Specifically, the first cell tray 11 is disposed in the box body 4, and the first cell tray 11 is spaced apart from the bottom portion of the box body 4, thereby forming the first pressure relief cavity 10. The first cell tray 11 is provided with a plurality of holes, where a position of each of the holes corresponds to a position of the explosion-proof valve at the bottom portion of respective one of the first cells 12. The pressure relief channel 41 is provided at the bottom portion of the box body 4. After the first cell tray 11 and the box body 4 form the first pressure relief cavity 10, the first pressure relief cavity 10 is respectively connected with the pressure relief channel 41 and the explosion-proof valves of the plurality of first cells 12. When thermal runaway occurs in one or more of the first cells 12, pressure relief gas can be released into the first pressure relief cavity 10 through the explosion-proof valves of the first cells 12, and then released to the outside of the battery pack 100 through the pressure relief channel 41 connected to the first pressure relief cavity 10.

Illustratively, as shown in FIGS. 3 and 5, the battery pack 100 includes three first battery modules 1, where each of the three first battery modules 1 has the same structure and includes one first cell tray 11, a plurality of first cells 12 and one first integrated busbar 13. Three first cell trays 11 are arranged at intervals in the box body 4, and form the first pressure relief cavity 10 together with the box body 4. The pressure relief channel 41 is provided at a circumferential position of the bottom portion of the box body 4. The first pressure relief cavity 10 is connected to the outside through the pressure relief channel 41 for releasing the pressure relief gas to the outside.

In some embodiments of the present disclosure, as shown in FIGS. 3-5, the battery pack 100 further includes a module frame 6 disposed above the first liquid cooling plate 31. The second battery module 2 includes a second cell tray 21, a plurality of second cells 22 and a second integrated busbar 23. The second cell tray 21 is disposed on a side of the module frame 6 away from the first liquid cooling plate 31, and the second cell tray 21 and the module frame 6 form a second pressure relief cavity 20. The plurality of second cells 22 are installed on the second cell tray 21. The second integrated busbar 23 is disposed on a side of the plurality of second cells 22 away from the second cell tray 21 and is connected to the plurality of second cells 22.

A support assembly 7 is disposed between the first cell tray 11 and the module frame 6 and is provided with one or more through holes 711. The first pressure relief cavity 10 is connected with the second pressure relief cavity 20 through the through holes 711, and the second pressure relief cavity 20 is connected with the explosion-proof valves of the plurality of second cells 22.

Where, the support assembly 7 can support the module frame 6 and the second battery module 2 located above the module frame 6 while the support assembly 7 is provided with a longitudinal through hole 711, through which the first pressure relief cavity 10 can be connected to the second pressure relief cavity 20. The second cell tray 21 is also provided with a plurality of holes, where a position of each of the holes corresponds to a position of the explosion-proof valve of respective one of the second cells 22. When thermal runaway occurs in one or more of the second cells 22, the pressure relief gas can be released into the second pressure relief cavity 20 through the explosion-proof valve at the bottom portion of the second cell 22, and then enter the first pressure relief cavity 10 through the through hole 711 in the support assembly 7, and finally released to the outside of the battery pack through the pressure relief channel 41 connected to the first pressure relief cavity 10.

Illustratively, as shown in FIGS. 3 and 4, the support assembly 7 includes a plurality of support beams 71, which are respectively disposed at four corners of the first cell tray 11 and a middle portion of the first cell tray 11 in its length direction and can provide good support for the module frame 6 and the second battery module 2. Each of the support beams 71 is provided with a through hole 711 in an up-down direction of the support beam 71, and the first pressure relief cavity 10 is connected to the second pressure relief cavity 20 through the through hole 711. Where, the module frame 6 may be an aluminum alloy module frame.

FIG. 5 is a schematic diagram of a pressure relief process when thermal runaway occurs in a second cell 22 in the second battery module 2, where a direction indicated by an arrow in the figure is a flow direction of the pressure relief gas. When the thermal runaway occurs in one of the second cells 22, the pressure relief gas is released from the explosion-proof valve of the second cell 22, and then enters the second pressure relief cavity 20 through the hole set at the corresponding position on the second cell tray 21, and then enters the first pressure relief cavity 10 through the through hole 711 in the support assembly 7, and finally released to the outside of the battery pack 100 through the pressure relief channel 41 connected to the first pressure relief cavity 10.

In the embodiments of the present disclosure, the first pressure relief cavity 10 and the second pressure relief cavity 20 are respectively connected to the explosion-proof valves of the first cells 12 and the explosion-proof valves of the second cells 22, the second pressure relief cavity 20 is connected to the first pressure relief cavity 10, and the first pressure relief cavity 10 is connected to the outside through the pressure relief channel 41 provided on the box body 4, thereby forming a relatively sealed pressure relief space. When thermal runaway occurs in a cell, gas-electric isolation can be achieved to prevent the pressure relief gas from affecting other components in the battery pack 100, thereby further improving the thermal safety performance of the battery pack 100.

In some embodiments of the present disclosure, as shown in FIG. 5, the battery pack 100 further includes a thermal insulation assembly 8, where the thermal insulation assembly 8 is located between the first liquid cooling plate 31 and the second battery module 2, and/or the thermal insulation assembly 8 is located on a side surface of the second liquid cooling plate 32 away from the second battery module 2.

The thermal insulation assembly 8 can effectively isolate the gas released during the thermal runaway. For example, when the thermal runaway occurs in the second battery module 2, the thermal insulation assembly 8 can prevent the pressure relief gas generated by the second battery module 2 from damaging the first liquid cooling plate 31 and the first battery module 1 located below the second battery module 2.

Illustratively, as shown in FIG. 5, the thermal insulation assembly 8 is located between the first liquid cooling plate 31 and the second battery module 2 and is attached to the surface of the first liquid cooling plate 31 to isolate the heat generated by the second battery module 2 when the second battery module 2 operates or the thermal runaway occurs in the second battery module 2.

In some embodiments of the present disclosure, the thermal insulation assembly 8 is a mica board, which has excellent high temperature resistance and can improve the thermal insulation effect.

In some embodiments of the present disclosure, the battery pack 100 further includes a first thermally conductive structural adhesive layer and a second thermally conductive structural adhesive layer. Where the first thermally conductive structural adhesive layer is disposed between the first liquid cooling plate 31 and the first battery module 1, and the second thermally conductive structural adhesive layer is disposed between the second liquid cooling plate 32 and the second battery module 2.

That is, the first liquid cooling plate 31 is fixedly connected to the first battery module 1 by the first thermally conductive structural adhesive layer, and the second liquid cooling plate 32 is fixedly connected to the second battery module 2 by the second thermally conductive structural adhesive, which can improve the stability of the connection while ensuring the thermal conductivity of the liquid cooling plates.

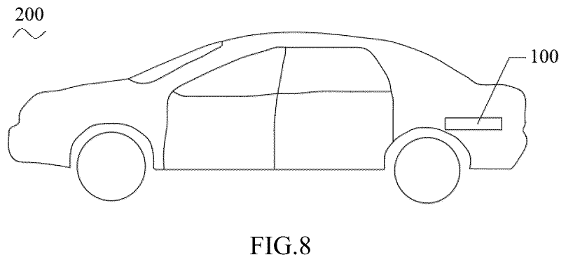

In some embodiments of the present disclosure, as shown in FIG. 7, the first liquid cooling plate 31 and the second liquid cooling plate 32 are provided with avoidance portions 313, where the avoidance portions 313 correspond to positions of components in the box body 4, and/or the avoidance portions 313 correspond to positions of components of the box cover 5.

Specifically, each of the avoidance portions 313 includes at least one of various forms such as protrusion, depression and hollowing portions. By providing the avoidance portions 313, the first liquid cooling plate 31 and the second liquid cooling plate 32 can be prevented from interfering with the components in the box body 4 and the box cover 5.

In some embodiments of the present disclosure, a plurality of connection columns 42 are provided in the box body 4, and a position of the box cover 5 corresponding to each of the connection columns 42 is provided with a connection hole 51, the connection column 42 is inserted into the connection hole 51, and the position of each of the avoidance portions 313 corresponds to the position of respective one of the connection columns 42.

Illustratively, the plurality of connection columns 42 provided in the box body 4 are internal threaded columns, and the box cover 5 is provided with connection holes 51 at corresponding positions of the box cover 5, and the box cover 5 can be fixedly connected to the box body 4 by the bolted connection, thereby improving the stability of the overall structure.

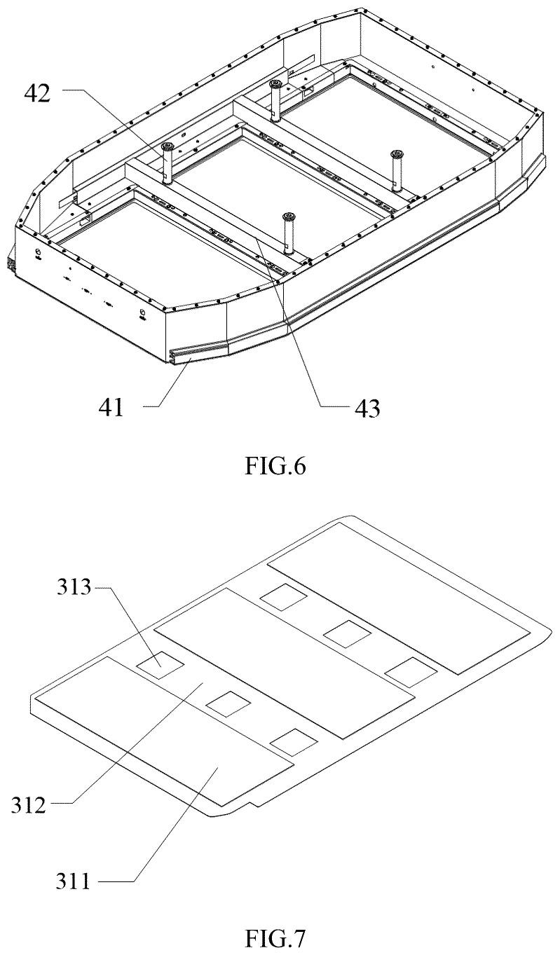

Specifically, as shown in FIG. 6, two cross beams 43 are disposed in middle positions of the box body 4 in its height direction, where each of the cross beams 43 is provided with two connection columns 42 at intervals. The connection columns 42 are cooperated with the connection holes 51 to form a middle ceiling structure, which can be used to suspend the battery pack 100.

Furthermore, when the battery pack 100 includes a plurality of first battery modules 1 and a plurality of second battery modules 2, the first liquid cooling plate 31 and the second liquid cooling plate 32 need to cover the plurality of first battery modules 1 and the second battery modules 2, respectively. As shown in FIG. 7, taking the first liquid cooling plate 31 as an example, the first liquid cooling plate 31 includes one or more liquid cooling portions 311 and one or more connection portions 312, where each of the liquid cooling portions 311 is provided with a liquid cooling channel. Each of the liquid cooling portions 311 can effectively cover respective one of the first battery modules 1, thereby improving heat dissipation capacity of the first battery modules 1. Each of the connection portions 312 is used to connect two adjacent liquid cooling portions 311. One or more avoidance portions 313 are provided in the connection portion 312, and are in a hollow form, so as to avoid the positions of the connection columns 42 and avoid interference with the connection columns 42.

That is, the avoidance portions 313 in the first liquid cooling plate 31 avoid the positions of the connection columns 42, and a hollow portion is formed at the position corresponding to each of the connection columns 42, thereby avoiding the interference between the first liquid cooling plate 31 and the connection columns 42.

It should be noted that, when there are other components in the battery pack 100 that can interfere with the first liquid cooling plate 31 and/or the second liquid cooling plate 32, other avoidance portions 313 may also be provided at the corresponding positions where the interference is formed. For example, the avoidance portion 313 may be provided at the position of the first liquid cooling plate 31 corresponding to the support assembly 7. In some embodiments of the present disclosure, the first cells and the second cells are 46-type large cylindrical battery cells.

The 46-type large cylindrical battery cells having a larger volume can hold more charge, and have higher capacity and energy density. Illustratively, the 46-type large cylindrical battery cells include at least one of 4680 battery cells, 4695 battery cells, and 46120 battery cells.

In a second aspect, as shown in FIG. 8, some embodiments of the present disclosure provide a vehicle 200, including the battery pack 100 as described above.

In the embodiments of the present disclosure, the battery pack 100 including the double-layer battery module can be formed by stacking the first battery module 1 and the second battery module 2. When the battery pack is installed in the vehicle 200, a Z-direction space of the entire vehicle can be fully utilized to meet the requirements of high energy and long endurance of the vehicle 200. The first liquid cooling plate 31 and the second liquid cooling plate 32 are respectively attached to the top portion of the first battery module 1 and the top portion of the second battery module 2, and can effectively liquid-cool positions of the first battery module 1 and the second battery module 2 during the operation of the battery pack 100, thereby meeting the liquid cooling requirements of the battery pack 100 and improving thermal safety and reliability of the battery pack 100, and further improving the safety of the vehicle 200.

What is claimed is:

1. A battery pack, comprising: at least one first battery module, at least one second battery module, and a liquid cooling system, wherein:
the second battery module and the first battery module are stacked in a first direction to form a double-layer battery module;
the liquid cooling system comprises a first liquid cooling plate and a second liquid cooling plate;
the first liquid cooling plate is located at an end of the first battery module and between the first battery module and the second battery module; and
the second liquid cooling plate is located at an end of the second battery module away from the first battery module.

2. The battery pack of claim 1, further comprising: a box body and a box cover, wherein:
the first battery module, the second battery module, and the liquid cooling plate are all disposed in the box body; and
the box cover covers the box body.

3. The battery pack of claim 2, wherein: the first battery module comprises a first cell tray, a plurality of first cells, and a first integrated busbar;
the first cell tray is disposed at a bottom portion of the box body and forms a first pressure relief cavity with the box body;
the plurality of first cells are installed on the first cell tray;
the first integrated busbar is disposed on a side of the plurality of first cells away from the first cell tray and is connected to the plurality of first cells; and
the box body is provided with a pressure relief channel, and the first pressure relief cavity is respectively connected with the pressure relief channel and explosion-proof valves of the plurality of first cells.

4. The battery pack of claim 3, further comprising: a module frame disposed between the first liquid cooling plate and the second battery module, wherein:
the second battery module comprises a second cell tray, a plurality of second cells, and a second integrated busbar;
the second cell tray is disposed on a side of the module frame away from the first liquid cooling plate, and the second cell tray forms a second pressure relief cavity with the module frame;
the plurality of second cells are installed on the second cell tray;
the second integrated busbar is disposed on a side of the plurality of second cells away from the second cell tray and is connected to the plurality of second cells;
a support assembly is disposed between the first cell tray and the module frame and is provided with one or more through holes; and the first pressure relief cavity is connected with the second pressure relief cavity through the through holes, and the second pressure relief cavity is connected with explosion-proof valves of the plurality of second cells.

5. The battery pack of claim 4, wherein the support assembly comprises a plurality of support beams, and the through holes are provided in the support beams.

6. The battery pack of claim 1, further comprising: a thermal insulation assembly, wherein the thermal insulation assembly is located between the first liquid cooling plate and the second battery module, and/or the thermal insulation assembly is located on a side surface of the second liquid cooling plate away from the second battery module.

7. The battery pack of claim 6, wherein the thermal insulation assembly is a mica board.

8. The battery pack of claim 1, further comprising: a first thermally conductive structural adhesive layer and a second thermally conductive structural adhesive layer, wherein:
the first thermally conductive structural adhesive layer is disposed between the first liquid cooling plate and the first battery module; and
the second thermally conductive structural adhesive layer is disposed between the second liquid cooling plate and the second battery module.

9. The battery pack of claim 2, wherein the first liquid cooling plate and the second liquid cooling plate are provided with avoidance portions, the avoidance portions corresponding to positions of components in the box body and/or corresponding to positions of components of the box cover.

10. The battery pack of claim 9, wherein the box body is provided with a plurality of connection columns, a position of the box cover corresponding to each of the connection columns is provided with a connection hole, the each of the connection columns is inserted into the connection hole, and a position of each of the avoidance portions corresponds to a position of respective one of the connection columns.

11. The battery pack of claim 10, wherein the box body is provided with a plurality of cross beams, and the connection columns are provided on the cross beams.

12. The battery pack of claim 11, wherein each of the connection columns comprises an internally threaded column, and a bolt is fixedly connected to the connection column through the connection hole to fixedly connect the box cover with the box body.

13. The battery pack of claim 9, wherein the first liquid cooling plate and the second liquid cooling plate each comprise one or more liquid cooling portions and one or more connection portions; and
each of the liquid cooling portions covers one first battery module or one second battery module, respectively, and each of the connection portions is configured to connect two adjacent ones of the liquid cooling portions.

14. The battery pack of claim 13, wherein the avoidance portions are provided on the connection portions.

15. The battery pack of claim 2, further comprising: a thermal insulation assembly, wherein the thermal insulation assembly is located between the first liquid cooling plate and the second battery module, and/or the thermal insulation assembly is located on a side surface of the second liquid cooling plate away from the second battery module.

16. The battery pack of claim 3, further comprising: a thermal insulation assembly, wherein the thermal insulation assembly is located between the first liquid cooling plate and the second battery module, and/or the thermal insulation assembly is located on a side surface of the second liquid cooling plate away from the second battery module.

17. The battery pack of claim 4, further comprising: a thermal insulation assembly, wherein the thermal insulation assembly is located between the first liquid cooling plate and the second battery module, and/or the thermal insulation assembly is located on a side surface of the second liquid cooling plate away from the second battery module.

18. The battery pack of claim 5, further comprising: a thermal insulation assembly, wherein the thermal insulation assembly is located between the first liquid cooling plate and the second battery module, and/or the thermal insulation assembly is located on a side surface of the second liquid cooling plate away from the second battery module.

19. The battery pack of claim 2, further comprising: a first thermally conductive structural adhesive layer and a second thermally conductive structural adhesive layer, wherein:
the first thermally conductive structural adhesive layer is disposed between the first liquid cooling plate and the first battery module; and
the second thermally conductive structural adhesive layer is disposed between the second liquid cooling plate and the second battery module.

20. A vehicle, comprising: a battery pack, comprising: at least one first battery module, at least one second battery module, and a liquid cooling system, wherein:
the second battery module and the first battery module are stacked in a first direction to form a double-layer battery module;
the liquid cooling system comprises a first liquid cooling plate and a second liquid cooling plate;
the first liquid cooling plate is located at an end of the first battery module and between the first battery module and the second battery module; and
the second liquid cooling plate is located at an end of the second battery module away from the first battery module.
